(19) United States
(12) Patent Application Publication
(10) Pub. No.: US 2021/0092159 A1
(43) Pub. Date: Mar. 25, 2021

(54) SYSTEM FOR THE PRIORITIZATION AND DYNAMIC PRESENTATION OF DIGITAL CONTENT

(71) Applicant: QOMPLX, Inc., Tysons, VA (US)

(72) Inventors: Jason Crabtree, Vienna, VA (US); Andrew Sellers, Monument, CO (US)

(21) Appl. No.: 16/945,656

(22) Filed: Jul. 31, 2020

Related U.S. Application Data
(63) Continuation-in-part of application No. 15/931,534, filed on May 13, 2020.
Application No. 15/931,534 is a continuation-in-part of application No. 16/777,270, filed on Jan. 30, 2020.
Application No. 16/777,270 is a continuation-in-part of application No. 16/720,383, filed on Dec. 19, 2019.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017.
Application No. 15/616,427 is a continuation-in-part of application No. 14/925,974, filed on Oct. 28, 2015.
Application No. 15/725,274 is a continuation-in-part of application No. 15/655,113, filed on Jul. 20, 2017, now Pat. No. 10,735,456.
Application No. 15/655,113 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016.
Application No. 15/206,195 is a continuation-in-part of application No. 15/186,453, filed on Jun. 18, 2016.
Application No. 15/186,453 is a continuation-in-part of application No. 15/166,158, filed on May 26, 2016.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015.
Application No. 14/925,974 is a continuation-in-part of application No. 15/931,534, filed on May 13, 2020.
Application No. 15/931,534 is a continuation-in-part of application No. 15/683,765, filed on Aug. 22, 2017.
Application No. 15/683,765 is a continuation-in-part of application No. 15/409,510, filed on Jan. 18, 2017.
Application No. 15/409,510 is a continuation-in-part of application No. 15/379,899, filed on Dec. 15, 2016.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/718,906, filed on Dec. 18, 2019.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/673,368, filed on Aug. 9, 2017.
Application No. 15/673,368 is a continuation-in-part of application No. 15/376,657, filed on Dec. 13, 2016, now Pat. No. 10,402,906.
Application No. 15/376,657 is a continuation-in-part of application No. 15/931,534, filed on May 13, 2020.
Application No. 15/931,534 is a continuation-in-part of application No. 16/718,906, filed on Dec. 18, 2019.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/489,716, filed on Apr. 17, 2017.
Application No. 15/489,716 is a continuation-in-part of application No. 15/409,510, filed on Jan. 18, 2017.
Application No. 15/409,510 is a continuation-in-part of application No. 15/931,534, filed on May 13, 2020.
Application No. 15/931,534 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/655,113 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017.
Application No. 15/616,427 is a continuation-in-part of application No. 15/141,752, filed on Apr. 28, 2016, now Pat. No. 10,860,962.
Application No. 15/141,752 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/489,716, filed on Apr. 17, 2017.
Application No. 15/489,716 is a continuation-in-part of application No. 15/616,427, filed on Jun. 7, 2017.
Application No. 15/616,427 is a continuation-in-part of application No. 14/925,974, filed on Oct. 28, 2015.
Application No. 14/925,974 is a continuation-in-part of application No. 15/931,534, filed on May 13, 2020.
Application No. 15/931,534 is a continuation-in-part of application No. 16/660,727, filed on Oct. 22, 2019.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016.
(60) Provisional application No. 62/568,298, filed on Oct. 4, 2017.
(60) Provisional application No. 62/568,291, filed on Oct. 4, 2017.

(51) Int. Cl. H04L 29/06; G06F 16/951; G06F 16/2458

(52) U.S. Cl. CPC H04L 63/20; H04L 63/1425; H04L 63/1441; G06F 16/2477; G06F 16/951

(57) ABSTRACT

A system and method for the prioritization and dynamic presentation of digital content. Application-specific and trained machine learning models recognize situational events via active and passive monitoring, triggering specialized load-balancing of critical network data as well as dynamically optimizing graphical user interfaces (GUI). GUI optimization comprises changing the layout composition; omitting non-critical information or changing the color, transparency, size, or other properties of the GUI elements. Furthermore, the system may activate electronic devices designed to alert users to recognize identified events.

### CROSS-REFERENCE TO RELATED APPLICATIONS

| Application | | |
|---|---|---|
| No. | Date Filed | Title |
| Current | Herewith | SYSTEM FOR THE |
| application | | PRIORITIZATION AND DYNAMIC |
| | | PRESENTATION OF DIGITAL |
| | | CONTENT |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/777,270 | Jan. 30, 2020 | CYBERSECURITY PROFILING AND |
| | | RATING USING ACTIVE AND |
| | | PASSIVE EXTERNAL |
| | | RECONNAISSANCE |
| | | which is a continuation-in-part of: |
| 16/720,383 | Dec. 19, 2019 | RATING ORGANIZATION |
| | | CYBERSECURITY USING ACTIVE |
| | | AND PASSIVE EXTERNAL |
| | | RECONNAISSANCE |
| | | which is a continuation of: |
| 15/823,363 | Nov. 27, 2017 | RATING ORGANIZATION |
| Patent | Issue Date | CYBERSECURITY USING ACTIVE |
| 10,560,483 | Feb. 11, 2020 | AND PASSIVE EXTERNAL |
| | | RECONNAISSANCE |
| | | which is a continuation-in-part of: |
| 15/725,274 | Oct. 4, 2017 | APPLICATION OF ADVANCED |
| Patent | Issue Date | CYBERSECURITY THREAT |
| 10,609,079 | Mar. 31, 2020 | MITIGATION TO ROGUE |
| | | DEVICES, PRIVILEGE |
| | | ESCALATION, AND RISK-BASED |
| | | VULNERABILITY AND PATCH |
| | | MANAGEMENT |
| | | which is a continuation-in-part of: |
| 15/655,113 | Jul. 20, 2017 | ADVANCED CYBERSECURITY |
| | | THREAT MITIGATION USING |
| | | BEHAVIORAL AND DEEP |
| | | ANALYTICS |
| | | which is a continuation-in-part of: |
| 15/616,427 | Jun. 7, 2017 | RAPID PREDICTIVE ANALYSIS OF |
| | | VERY LARGE DATA SETS USING |
| | | AN ACTOR-DRIVEN DISTRIBUTED |
| | | COMPUTATIONAL GRAPH |
| | | which is a continuation-in-part of: |
| 14/925,974 | Oct. 28, 2015 | RAPID PREDICTIVE ANALYSIS OF |
| | | VERY LARGE DATA SETS USING |
| | | THE DISTRIBUTED |
| | | COMPUTATIONAL GRAPH |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/777,270 | Jan. 30, 2020 | CYBERSECURITY PROFILING AND |
| | | RATING USING ACTIVE AND |
| | | PASSIVE EXTERNAL |
| | | RECONNAISSANCE |
| | | which is a continuation-in-part of: |
| 16/720,383 | Dec. 19, 2019 | RATING ORGANIZATION |
| | | CYBERSECURITY USING ACTIVE |
| | | AND PASSIVE EXTERNAL |
| | | RECONNAISSANCE |
| | | which is a continuation of: |
| 15/823,363 | Nov. 27, 2017 | RATING ORGANIZATION |
| Patent | Issue Date | CYBERSECURITY USING ACTIVE |
| 10,560,483 | Feb. 11, 2020 | AND PASSIVE EXTERNAL |
| | | RECONNAISSANCE |
| | | which is a continuation-in-part of: |
| 15/725,274 | Oct. 4, 2017 | APPLICATION OF ADVANCED |
| Patent | Issue Date | CYBERSECURITY THREAT |
| 10,609,079 | Mar. 31, 2020 | MITIGATION TO ROGUE |
| | | DEVICES, PRIVILEGE |
| | | ESCALATION, AND RISK-BASED |
| | | VULNERABILITY AND PATCH |
| | | MANAGEMENT |
| | | which is a continuation-in-part of: |
| 15/655,113 | Jul. 20, 2017 | ADVANCED CYBERSECURITY |
| | | THREAT MITIGATION USING |
| | | BEHAVIORAL AND DEEP |
| | | ANALYTICS |
| | | which is also a continuation-in-part of: |
| 15/237,625 | Aug. 15, 2016 | DETECTION MITIGATION AND |
| Patent | Issue Date | REMEDIATION OF |
| 10,248,910 | Apr. 2, 2019 | CYBERATTACKS EMPLOYING AN |
| | | ADVANCED CYBER-DECISION |
| | | PLATFORM |
| | | which is a continuation-in-part of: |
| 15/206,195 | Jul. 8, 2018 | ACCURATE AND DETAILED |
| | | MODELING OF SYSTEMS WITH |
| | | LARGE COMPLEX DATASETS |
| | | USING A DISTRIBUTED |
| | | SIMULATION ENGINE |
| | | which is a continuation-in-part of: |
| 15/186,453 | Jun. 18, 2016 | SYSTEM FOR AUTOMATED |
| | | CAPTURE AND ANALYSIS OF |
| | | BUSINESS INFORMATION FOR |
| | | RELIABLE BUSINESS VENTURE |
| | | OUTCOME PREDICTION |
| | | which is a continuation-in-part of: |
| 15/166,158 | May 26, 2016 | SYSTEM FOR AUTOMATED |
| | | CAPTURE AND ANALYSIS OF |
| | | BUSINESS INFORMATION FOR |
| | | SECURITY AND CLIENT-FACING |
| | | INFRASTRUCTURE RELIABILITY |
| | | which is a continuation-in-part of: |
| 15/141,752 | Apr. 28, 2016 | SYSTEM FOR FULLY INTEGRATED |
| | | CAPTURE, AND ANALYSIS OF |
| | | BUSINESS INFORMATION |
| | | RESULTING IN PREDICTIVE |
| | | DECISION MAKING AND |
| | | SIMULATION |
| | | which is a continuation-in-part of: |
| 15/091,563 | Apr. 5, 2016 | SYSTEM FOR CAPTURE, ANALYSIS |
| Patent | Issue Date | AND STORAGE OF TIME SERIES |
| 10,204,147 | Feb. 12, 2019 | DATA FROM SENSORS WITH |
| | | HETEROGENEOUS REPORT |
| | | INTERVAL PROFILES |
| | | and is also a continuation-in-part of: |
| 14/986,536 | Dec. 31, 2015 | DISTRIBUTED SYSTEM FOR |
| Patent | Issue Date | LARGE VOLUME DEEP WEB DATA |
| 10,210,255 | Feb. 19, 2019 | EXTRACTION |
| | | and is also a continuation-in-part of: |
| 14/925,974 | Oct. 28, 2015 | RAPID PREDICTIVE ANALYSIS OF |
| | | VERY LARGE DATA SETS USING |
| | | THE DISTRIBUTED |
| | | COMPUTATIONAL GRAPH |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 15/683,765 | Aug. 22, 2017 | PREDICTIVE LOAD BALANCING |
| | | FOR A DIGITAL ENVIRONMENT |
| | | which is a continuation-in-part of: |
| 15/409,510 | Jan. 18, 2017 | MULTI-CORPORATION VENTURE |
| | | PLAN VALIDATION EMPLOYING |
| | | AN ADVANCED DECISION |
| | | PLATFORM |
| | | which is a continuation-in-part of: |
| 15/379,899 | Dec. 15, 2016 | INCLUSION OF TIME SERIES |
| | | GEOSPATIAL MARKERS IN |
| | | ANALYSES EMPLOYING AN |
| | | ADVANCED CYBER-DECISION |
| | | PLATFORM |
| | | which is a continuation-in-part of: |
| 15/376,657 | Dec. 13, 2016 | QUANTIFICATION FOR |
| Patent | Issue Date | INVESTMENT VEHICLE |
| 10,402,906 | Sep. 3, 2019 | MANAGEMENT EMPLOYING AN |
| | | ADVANCED DECISION PLATFORM |
| | | which is a continuation-in-part of: |
| 15/237,625 | Aug. 15, 2016 | DETECTION MITIGATION AND |
| Patent | Issue Date | REMEDIATION OF |
| 10,248,910 | Apr. 2, 2019 | CYBERATTACKS EMPLOYING AN |
| | | ADVANCED CYBER-DECISION |
| | | PLATFORM |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/718,906 | Dec. 18, 2019 | PLATFORM FOR HIERARCHY |
| | | COOPERATIVE COMPUTING |
| | | which is a continuation of: |
| 15/879,182 | Jan. 24, 2018 | PLATFORM FOR HIERARCHY |
| Patent | Issue Date | COOPERATIVE COMPUTING |
| 10,514,954 | Dec. 24, 2019 | which is a continuation-in-part of: |
| 15/850,037 | Dec. 21, 2017 | ADVANCED DECENTRALIZED |
| | | FINANCIAL DECISION PLATFORM |
| | | which is a continuation-in-part of: |
| 15/673,368 | Aug. 9, 2017 | AUTOMATED SELECTION AND |
| | | PROCESSING OF FINANCIAL |
| | | MODELS |
| | | which is a continuation-in-part of: |
| 15/376,657 | Dec. 13, 2016 | QUANTIFICATION FOR |
| Patent | Issue Date | INVESTMENT VEHICLE |
| 10,402,906 | Sep. 3, 2019 | MANAGEMENT EMPLOYING AN |
| | | ADVANCED DECISION PLATFORM |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/718,906 | Dec. 18, 2019 | PLATFORM FOR HIERARCHY |
| | | COOPERATIVE COMPUTING |
| | | which is a continuation of: |
| 15/879,182 | Jan. 24, 2018 | PLATFORM FOR HIERARCHY |
| Patent | Issue Date | COOPERATIVE COMPUTING |
| 10,514,954 | Dec. 24, 2019 | which is a continuation-in-part of: |
| 15/850,037 | Dec. 21, 2017 | ADVANCED DECENTRALIZED |
| | | FINANCIAL DECISION PLATFORM |
| | | which is a continuation-in-part of: |
| 15/489,716 | Apr. 17, 2017 | REGULATION BASED SWITCHING |
| | | SYSTEM FOR ELECTRONIC |
| | | MESSAGE ROUTING |
| | | which is a continuation-in-part of: |
| 15/409,510 | Jan. 18, 2017 | MULTI-CORPORATION VENTURE |
| | | PLAN VALIDATION EMPLOYING |
| | | AN ADVANCED DECISION |
| | | PLATFORM |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 15/905,041 | Feb. 28, 2018 | AUTOMATED SCALABLE |
| Patent | Issue Date | CONTEXTUAL DATA |
| 10,706,063 | Jul. 7, 2020 | COLLECTION AND EXTRACTION |
| | | SYSTEM |
| | | which is a continuation-in-part of: |
| 15/237,625 | Aug. 15, 2016 | DETECTION MITIGATION AND |
| Patent | Issue Date | REMEDIATION OF |
| 10,248,910 | Apr. 2, 2019 | CYBERATTACKS EMPLOYING AN |
| | | ADVANCED CYBER-DECISION |
| | | PLATFORM |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/191,054 | Nov. 14, 2018 | SYSTEM AND METHOD FOR |
| Patent | Issue Date | COMPREHENSIVE DATA LOSS |
| 10,681,074 | Jun. 9, 2020 | PREVENTION AND COMPLIANCE |
| | | MANAGEMENT |
| | | which is a continuation-in-part of: |
| 15/655,113 | Jul. 20, 2017 | ADVANCED CYBERSECURITY |
| | | THREAT MITIGATION USING |
| | | BEHAVIORAL AND DEEP |
| | | ANALYTICS |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/654,309 | Oct. 16, 2019 | SYSTEM AND METHOD |
| | | AUTOMATED ANALYSIS OF |
| | | LEGAL DOCUMENTS WITHIN AND |
| | | ACROSS SPECIFIC FIELDS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/790,457 | Oct. 23, 2017 | DISTRIBUTABLE MODEL WITH |
| | | BIASES CONTAINED WITHIN |
| | | DISTRIBUTED DATA |
| | | which claims benefit of, and priority to: |
| 62/568,298 | Oct. 4, 2017 | DISTRIBUTABLE MODEL WITH |
| | | BIASES CONTAINED IN |
| | | DISTRIBUTED DATA |
| | | and is also a continuation-in-part of: |
| 15/790,327 | Oct. 23, 2017 | DISTRIBUTABLE MODEL WITH |
| | | DISTRIBUTED DATA |
| | | which claims benefit of and priority to: |
| 62/568,291 | Oct. 4, 2017 | DISTRIBUTABLE MODEL WITH |
| | | DISTRIBUTED DATA |
| | | and is also a continuation-in-part of: |
| 15/616,427 | Jun. 7, 2017 | RAPID PREDICTIVE ANALYSIS OF |
| | | VERY LARGE DATA SETS USING |
| | | AN ACTOR-DRIVEN DISTRIBUTED |
| | | COMPUTATIONAL GRAPH |
| | | and is also a continuation-in-part of: |
| 15/141,752 | Apr. 28, 2016 | SYSTEM FOR FULLY INTEGRATED |
| | | CAPTURE, AND ANALYSIS OF |
| | | BUSINESS INFORMATION |
| | | RESULTING IN PREDICTIVE |
| | | DECISION MAKING AND |
| | | SIMULATION |
| Current | Herewith | CYBERSECURITY PROFILING AND |
| application | | RATING USING ACTIVE AND |
| | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/654,309 | Oct. 16, 2019 | SYSTEM AND METHOD |
| | | AUTOMATED ANALYSIS OF |
| | | LEGAL DOCUMENTS WITHIN AND |
| | | ACROSS SPECIFIC FIELDS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/489,716 | Apr. 17, 2017 | REGULATION BASED SWITCHING |
| | | SYSTEM FOR ELECTRONIC |
| | | MESSAGE ROUTING |
| | | and is also a continuation-in-part of: |
| 15/616,427 | Jun. 7, 2017 | RAPID PREDICTIVE ANALYSIS OF |
| | | VERY LARGE DATA SETS USING |
| | | AN ACTOR-DRIVEN DISTRIBUTED |
| | | COMPUTATIONAL GRAPH |
| | | which is a continuation-in-part of: |
| 14/925,974 | Oct. 28, 2015 | RAPID PREDICTIVE ANALYSIS OF |
| | | VERY LARGE DATA SETS USING |
| | | AN ACTOR-DRIVEN DISTRIBUTED |
| | | COMPUTATIONAL GRAPH |
| | | CYBERSECURITY PROFILING AND |
| Current | Herewith | RATING USING ACTIVE AND |
| application | | PASSIVE EXTERNAL |
| | | RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/660,727 | Oct. 22, 2019 | HIGHLY SCALABLE DISTRIBUTED |
| | | CONNECTION INTERFACE FOR |
| | | DATA CAPTURE FROM MULTIPLE |
| | | NETWORK SERVICE SOURCES |
| | | which is a continuation of: |
| 15/229,476 | Aug. 5, 2016 | HIGHLY SCALABLE DISTRIBUTED |
| Patent | Issue Date | CONNECTION INTERFACE FOR |
| 10,454,791 | Oct. 22, 2019 | DATA CAPTURE FROM MULTIPLE |
| | | NETWORK SERVICE SOURCES |
| | | which is a continuation-in-part of: |
| 15/206,195 | Jul. 8, 2016 | ACCURATE AND DETAILED |
| | | MODELING OF SYSTEMS WITH |
| | | LARGE COMPLEX DATASETS |
| | | USING A DISTRIBUTED |
| | | SIMULATION ENGINE |

the entire specification of each of which is incorporated herein by reference.

### BACKGROUND OF THE INVENTION

### Field of the Invention

The disclosure relates to the field of computer technology, and particularly to graphical user interfaces, digital experience monitoring, and load-balancing.

### Discussion of the State of the Art

Current computer-user interfaces do a poor job of conveying prioritized information to users. First, they lack any capability to determine information priorities, so cannot display information in any priority. Second, they are often static in nature, and require manual manipulation and curation by the user of windows and other graphical elements to organize and prioritize information. Third, in situations where there is insufficient bandwidth or other computing resources, they lack any capability to perform prioritization of different sourced data streams or, in the case of distributed systems, load balancing. The modern approach to load balancing a distributed system relies on the reallocation of server resources, not the client's. This is partly due to the fact that software applications have no load-balancing efforts of their own and thus cannot effectively mitigate hang-ups or crashes or restrictions in information availability.

What is needed is a system and method that can monitor a user's computer experience for purposes of prioritizing information for the user, modulate software application interfaces to optimize the information displayed, and further monitor and optimize network devices, and data traffic by monitoring and analyzing system and network data resulting in fault-tolerant dynamic software applications which can prioritize information for a user even in situations where bandwidth or computing resources are restricted.

### SUMMARY OF THE INVENTION

Accordingly, the inventor has developed a system and method for the prioritization and dynamic presentation of digital content. Application-specific and trained machine learning models recognize situational events via active and passive monitoring, triggering specialized load-balancing of critical network data as well as dynamically optimizing graphical user interfaces (GUI). GUI optimization may comprise any number of alterations to the GUI including, but not limited to, changing the layout composition, omitting non-critical information, or changing the color, transparency, size, or other properties of the GUI elements. Furthermore, the system may activate electronic devices designed to alert users to recognize identified events.

According to a preferred embodiment, a system for the prioritization and dynamic presentation of digital content, comprising: a first network-connected computing device comprising a non-volatile storage device, a memory, and a processor; an event monitor comprising a first plurality of programming instructions stored in the memory of, and operating on the processor of, the first computing device, wherein the first plurality of programming instructions, when operating on the processor of the computing device, cause the computing device to: monitor and collect event data from one or more second network-connected computing devices, the event data comprising system log data; send the event data to a graph engine; and a graph engine comprising a second plurality of programming instructions stored in the memory of, and operating on the processor of, the first computing device, wherein the second plurality of programming instructions, when operating on the processor of the computing device, cause the computing device to: receive the event data from the event monitor; use a first machine learning algorithm to generate a directed graph comprising vertices representing event data points and edges representing relationships between the event data points; use a second machine learning algorithm on the directed graph to: identify a significant event based on clustering of event data points in the directed graph; relate the significant event to a unique ticket; transmit the unique ticket to a content optimizer; and a content optimizer comprising a third plurality of programming instructions stored in the memory of, and operating on the processor of, the first computing device, wherein the third plurality of programming instructions, when operating on the processor of the computing device, cause the computing device to: receive the unique ticket from the graph engine; alter an element of a graphical user interface of one of the one or more second network-connected computing devices based on the unique ticket.

According to a preferred embodiment, a method for prioritization and dynamic presentation of digital content, comprising the steps of: monitoring and collecting event data from one or more second network-connected computing devices, the event data comprising system log data; using a first machine learning algorithm to generate a directed graph comprising vertices representing event data points and edges representing relationships between the event data points; using a second machine learning algorithm on the directed graph to: identify a significant event based on clustering of event data points in the directed graph; relate the significant event to a unique ticket; alter an element of a graphical user interface of one of the one or more second network-connected computing devices based on the unique ticket.

According to an aspect of an embodiment, the system further comprising a load balancer comprising a fourth plurality of programming instructions stored in the memory of, and operating on the processor of, the first computing device, wherein the fourth plurality of programming instructions, when operating on the processor of the computing device, cause the computing device to: receive the unique ticket; identify a restriction of computing resources in one of the one or more second network-connected computing devices; change a resource allocation in one or more of the second network-connected computing devices to which the one or more second computing devices is connected to prioritize the transmission or processing of data.

According to an aspect of an embodiment, wherein the element of the graphical user interface is increased or decreased in size.

According to an aspect of an embodiment, wherein the element of the graphical user interface is changed in color or transparency.

According to an aspect of an embodiment, wherein the element of the graphical user interface is placed on top of other elements on the graphical user interface.

According to an aspect of an embodiment, wherein the elements of the graphical user interface are automatically rearranged on the graphical user interface.

According to an aspect of an embodiment, further comprising an external notification device, wherein the external notification device is used in addition to changes in the graphical user interface to direct attention to the significant event.

According to an aspect of an embodiment, wherein the external notification device is an audio generating device.

According to an aspect of an embodiment, wherein the external notification device is a light generating device.

According to an aspect of an embodiment, wherein the external notification device is a vibrating device.

According to an aspect of an embodiment, wherein the external notification device is a motor which physically moves the monitor on which the graphical user interface is displayed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram of an exemplary system architecture for an advanced cyber decision platform.

FIG. 2 is a block diagram of an advanced cyber decision platform in an exemplary configuration for use in investment vehicle management.

FIGS. 3A and 3B are process diagrams showing further detail regarding the operation of the advanced cyber decision platform.

FIG. 4 is a block diagram of an exemplary system architecture for a digital content management system 410.

FIG. 5 is a block diagram illustrating an exemplary embodiment of a digital content management system for use in a labor and delivery ward.

FIG. 6 is a flow diagram of an exemplary method for the system operation of the digital content management system.

FIG. 7 is a block diagram illustrating an exemplary hardware architecture of a computing device.

FIG. 8 is a block diagram illustrating an exemplary logical architecture for a client device.

FIG. 9 is a block diagram illustrating an exemplary architectural arrangement of clients, servers, and external services.

FIG. 10 is another block diagram illustrating an exemplary hardware architecture of a computing device.

### DETAILED DESCRIPTION

The inventor has conceived, and reduced to practice, a system and method for the prioritization and dynamic presentation of digital content. Application-specific and trained machine learning models recognize situational events via active and passive monitoring. Recognized events trigger specialized load-balancing of critical network data as well as dynamically changing graphical user interfaces (GUI) or otherwise alerting the user. The changes may comprise any number of alterations to the GUI including, but not limited to, altering the composition of the GUI layout, omitting non-critical information, changing the color, transparency, or size, and other properties of GUI elements. Furthermore, the system may activate electronic devices designed to alert users as events occur. Examples of applications extend to emergency services, network operations centers, hospitals, and any operations in which timely decisions are critical for the proper execution of duties and responsibilities.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context,” as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

As used herein, “Digital Experience Monitoring,” or DEM, is the end-to-end monitoring of aspects of a user's experience while interacting with computer technology, such as utilization intensity, load times, lag times, code analysis, and other factors integral in the process of using computer technology for a particular application. DEM may include use of some existing monitoring technologies, such as: application performance management (APM), real-user monitoring (RUM), browser telemetry JavaScript injection); synthetic transaction monitoring (STM); synthetic network path analysis; end user experience monitoring (EUEM) via agents, and network performance monitoring and diagnostics (NPMD). Technologies such as these work by actively or passively monitoring real users as the access applications in real time. They may instrument bytecode (facilitating real-time Java code modification) during runtime and analyze the transaction flow through every tier of the application architecture to isolate where latency or errors occurs. Additional tracing of user inputs such as cursor tracking and keyboard inputs reveal color-coded heatmaps. Alongside tracking user experiences, DEM includes topological network discovery, hop-by-hop routing information, including latency, packet loss, jitter, DNS, and QoS data. DEM encompasses the analysis of the complete list of physical and logical dependencies needed to facilitate user interactions with computer technology.

An “element” as used herein, refers to any graphic drawn on a display as part of a graphical user interface used to represent information stored in a computer. Elements comprise input controls (e.g., checkboxes, radio buttons, dropdown lists, list boxes, buttons, toggles, text fields, date field), navigational components (e.g., breadcrumbs, sliders, search fields, pagination, tags, icons), informational components (e.g., tooltips, icons, progress bars, notifications, message boxes, modal windows), and containers (accordions).

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB 08/13/1965” and “speaks English”. Similar to the use of properties to further describe the information in a node, a relationship between two nodes that forms an edge can be qualified using a “label”. Thus, given a second node “Thomas G,” an edge between lames R″ and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

A “pipeline,” as used herein and interchangeably referred to as a “data pipeline” or a “processing pipeline,” refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as a example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

### Conceptual Architecture

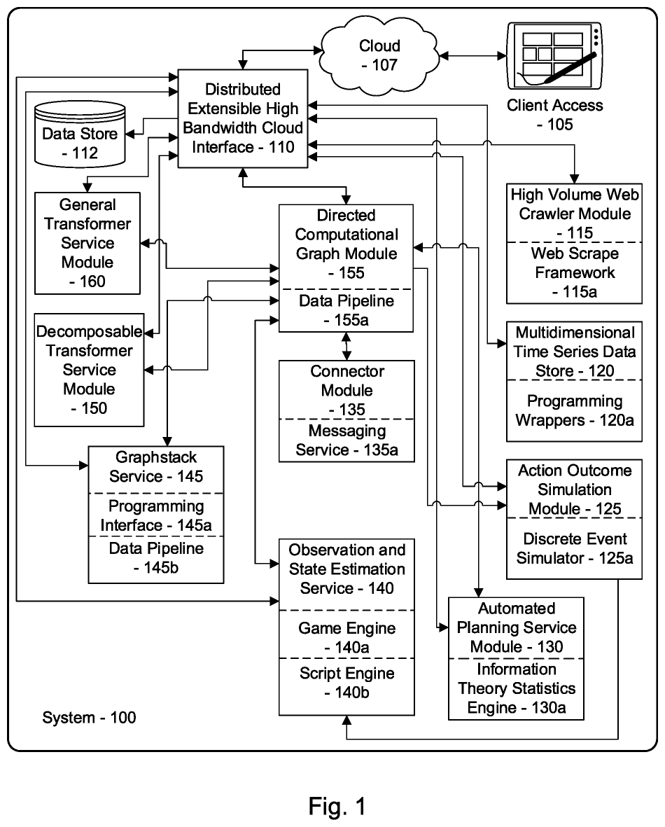

FIG. 1 is a block diagram of an advanced cyber decision platform. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™ CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database (MDTSDB) 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers 120a for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database (MDTSDB) 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

When performing external reconnaissance via a network 107, web crawler 115 may be used to perform a variety of port and service scanning operations on a plurality of hosts. This may be used to target individual network hosts (for example, to examine a specific server or client device) or to broadly scan any number of hosts (such as all hosts within a particular domain, or any number of hosts up to the complete IPv4 address space). Port scanning is primarily used for gathering information about hosts and services connected to a network, using probe messages sent to hosts that prompt a response from that host. Port scanning is generally centered around the transmission control protocol (TCP), and using the information provided in a prompted response a port scan can provide information about network and application layers on the targeted host.

Port scan results can yield information on open, closed, or undetermined ports on a target host. An open port indicated that an application or service is accepting connections on this port (such as ports used for receiving customer web traffic on a web server), and these ports generally disclose the greatest quantity of useful information about the host. A closed port indicates that no application or service is listening for connections on that port, and still provides information about the host such as revealing the operating system of the host, which may discovered by fingerprinting the TCP/IP stack in a response. Different operating systems exhibit identifiable behaviors when populating TCP fields, and collecting multiple responses and matching the fields against a database of known fingerprints makes it possible to determine the OS of the host even when no ports are open. An undetermined port is one that does not produce a requested response, generally because the port is being filtered by a firewall on the host or between the host and the network (for example, a corporate firewall behind which all internal servers operate).

Scanning may be defined by scope to limit the scan according to two dimensions, hosts and ports. A horizontal scan checks the same port on multiple hosts, often used by attackers to check for an open port on any available hosts to select a target for an attack that exploits a vulnerability using that port. This type of scan is also useful for security audits, to ensure that vulnerabilities are not exposed on any of the target hosts. A vertical scan defines multiple ports to examine on a single host, for example a “vanilla scan” which targets every port of a single host, or a “strobe scan” that targets a small subset of ports on the host. This type of scan is usually performed for vulnerability detection on single systems, and due to the single-host nature is impractical for large network scans. A block scan combines elements of both horizontal and vertical scanning, to scan multiple ports on multiple hosts. This type of scan is useful for a variety of service discovery and data collection tasks, as it allows a broad scan of many hosts (up to the entire Internet, using the complete IPv4 address space) for a number of desired ports in a single sweep.

Large port scans involve quantitative research, and as such may be treated as experimental scientific measurement and are subject to measurement and quality standards to ensure the usefulness of results. To avoid observational errors during measurement, results must be precise (describing a degree of relative proximity between individual measured values), accurate (describing relative proximity of measured values to a reference value), preserve any metadata that accompanies the measured data, avoid misinterpretation of data due to faulty measurement execution, and must be well-calibrated to efficiently expose and address issues of inaccuracy or misinterpretation. In addition to these basic requirements, large volumes of data may lead to unexpected behavior of analysis tools, and extracting a subset to perform initial analysis may help to provide an initial overview before working with the complete data set. Analysis should also be reproducible, as with all experimental science, and should incorporate publicly-available data to add value to the comprehensibility of the research as well as contributing to a “common framework” that may be used to confirm results.

When performing a port scan, web crawler 115 may employ a variety of software suitable for the task, such as Nmap, ZMap, or masscan. Nmap is suitable for large scans as well as scanning individual hosts, and excels in offering a variety of diverse scanning techniques. ZMap is a newer application and unlike Nmap (which is more general-purpose), ZMap is designed specifically with Internet-wide scans as the intent. As a result, ZMap is far less customizable and relies on horizontal port scans for functionality, achieving fast scan times using techniques of probe randomization (randomizing the order in which probes are sent to hosts, minimizing network saturation) and asynchronous design (utilizing stateless operation to send and receive packets in separate processing threads). Masscan uses the same asynchronous operation model of ZMap, as well as probe randomization. In masscan however, a certain degree of statistical randomness is sacrificed to improve computation time for large scans (such as when scanning the entire IPv4 address space), using the BlackRock algorithm. This is a modified implementation of symmetric encryption algorithm DES, with fewer rounds and modulo operations in place of binary ones to allow for arbitrary ranges and achieve faster computation time for large data sets.

Received scan responses may be collected and processed through a plurality of data pipelines 155a to analyze the collected information. MDTSDB 120 and graph stack 145 may be used to produce a hybrid graph/time-series database using the analyzed data, forming a graph of Internet-accessible organization resources and their evolving state information over time. Customer-specific profiling and scanning information may be linked to CPG graphs (as described below in detail, referring to FIG. 11) for a particular customer, but this information may be further linked to the base-level graph of internet-accessible resources and information. Depending on customer authorizations and legal or regulatory restrictions and authorizations, techniques used may involve both passive, semi-passive and active scanning and reconnaissance.

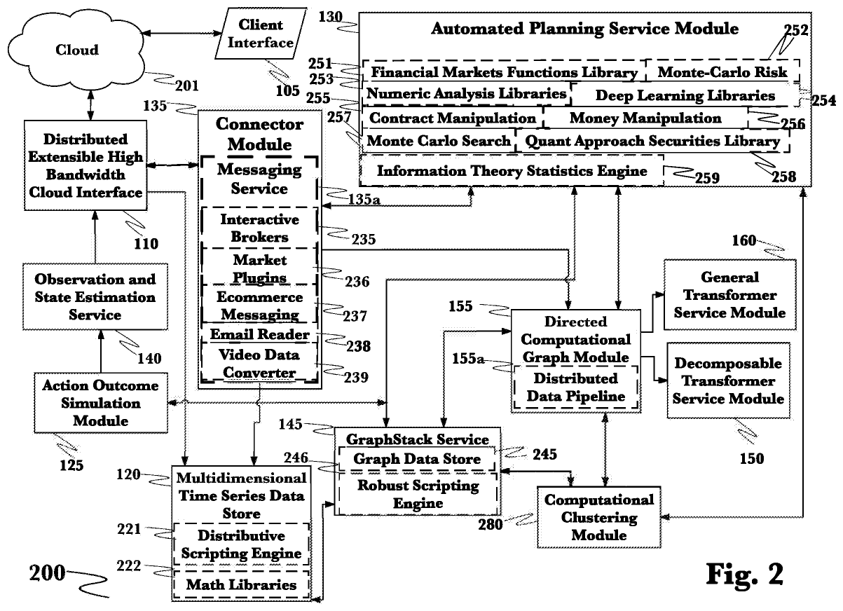

FIG. 2 is a block diagram of an advanced cyber decision platform in an exemplary configuration for use in investment vehicle management 200. The advanced cyber decision platform 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations 202 to produce investment predictions. Much of the trading specific programming functions are added to the automated planning service module 130 of the modified advanced cyber decision platform 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the advanced cyber decision platform may also perform significant analytical transformations on trade related data. These may include the multidimensional time series data store 120 with its robust scripting features which may include a distributive friendly, fault-tolerant, real-time, continuous run prioritizing, programming platform such as, but not limited to Erlang/OTP 221 and a compatible but comprehensive and proven library of math functions of which the C++ math libraries are an example 222, data formalization and ability to capture time series data including irregularly transmitted, burst data; the GraphStack service 145 which transforms data into graphical representations for relational analysis and may use packages for graph format data storage such as Titan 245 or the like and a highly interface accessible programming interface an example of which may be Akka/Spray, although other, similar, combinations may equally serve the same purpose in this role 246 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized and then intricate transformations such as those that may be associated with deep machine learning, first disclosed in ¶067 of co-pending application Ser. No. 14/925,974, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 280 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

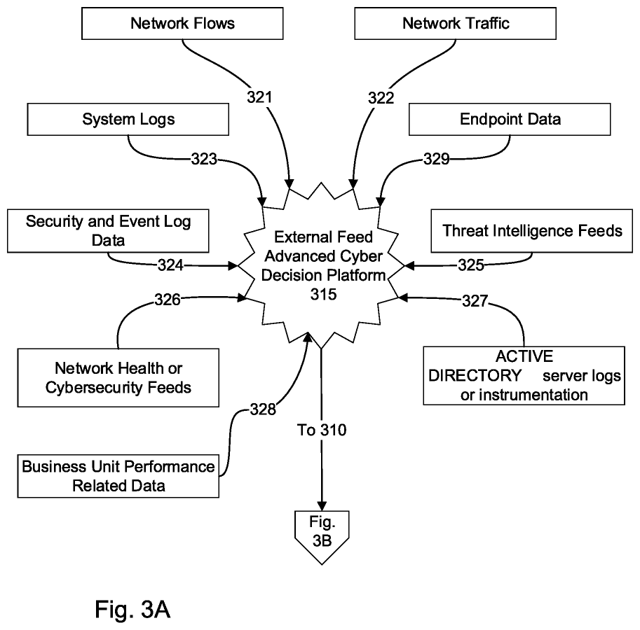

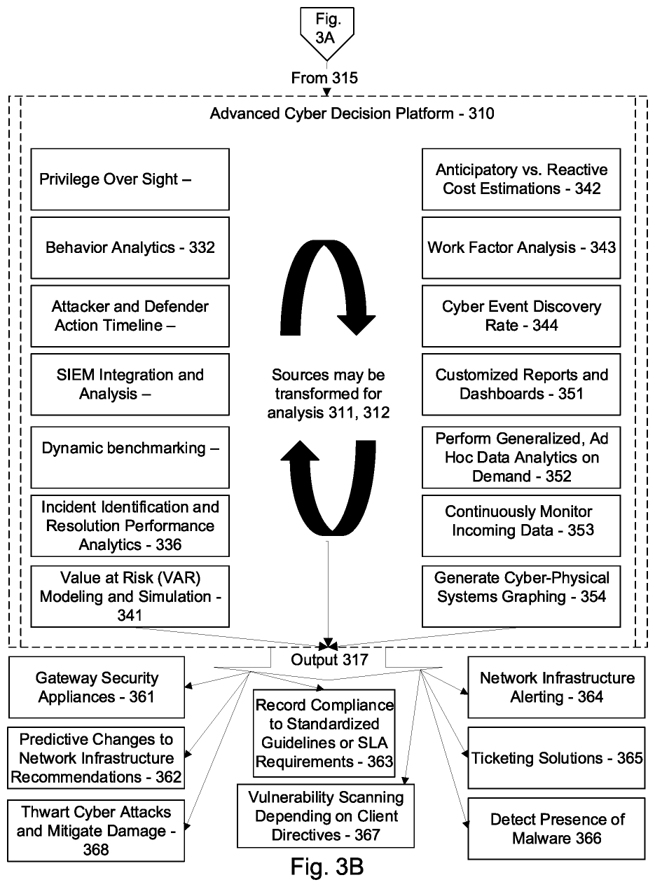

FIGS. 3A and 3B are process diagrams showing further detail regarding the operation of the advanced cyber decision platform. Input network data which may include network flow patterns 321, the origin and destination of each piece of measurable network traffic 322, system logs from servers and workstations on the network 323, endpoint data 329, any security event log data from servers or available security information and event (SIEM) systems 324, external threat intelligence feeds 324, identity or assessment context 325, external network health or cybersecurity feeds 326, Kerberos domain controller or ACTIVE DIRECTORY™ server logs or instrumentation 327, business unit performance related data 328, endpoint data 329, among many other possible data types for which the invention was designed to analyze and integrate, may pass into 315 the advanced cyber decision platform 310 for analysis as part of its cyber security function. These multiple types of data from a plurality of sources may be transformed for analysis 311, 312 using at least one of the specialized cybersecurity, risk assessment or common functions of the advanced cyber decision platform in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the advanced cyber decision platform's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 362, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, perform one time or continuous vulnerability scanning depending on client directives 367, and thwart or mitigate damage from cyber-attacks 368. These examples are, of course, only a subset of the possible uses of the system, they are exemplary in nature and do not reflect any boundaries in the capabilities of the invention.

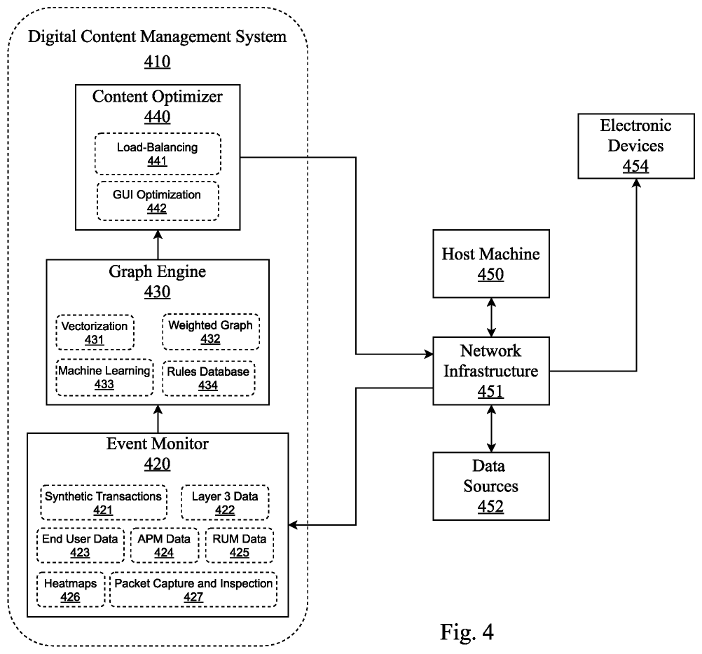

FIG. 4 is a block diagram of an exemplary system architecture for a digital content management system (DCMS) 410. The DCMS 410 includes an event monitor 420 that employs digital experience monitoring (DEM), i.e., passive and active data monitoring of host machines 450, network infrastructures 451, and data sources 452. Monitoring techniques utilized comprise application-layer synthetic transactions 421, layer 3 active network monitoring 422, end user experience monitoring 423, application performance monitoring (APM) 424, real user monitoring (RUM) code injection 425, heatmaps 426, and packet capture and inspection 427. The event monitor 420 sends the data log to a graph engine 430. In some embodiments, the event monitor 420 reduces all monitored information into a unified data log.

In some embodiments, the graph engine 430 receives the log data and transforms each individual log entry or event into a vector 431. Vectors are then associated with a vertex in a directed graph 432 and then vertices that are sufficiently close to each other across one or more dimensions or are otherwise related are connected by edges. The edges between vertices may be weighted or unweighted. Edge weights, when used, may be based on the distance between vertices.

In other embodiments, the graph engine 430 may use machine learning algorithms 432 to construct a directed graph of the log data wherein log events are represented as vertices in the graph and relationships between events are represented as edges between the vertices. The directed graph of events may, in some embodiments, be incorporated into a cyber-physical graph 432, which visually represents the relationships between physical and logical entities in a network. The vertices of the directed graph may be assigned vector representations.

Once the graph is formed, it may be processed through additional machine learning algorithms 433 to detect clustering of vertices which may signify a sequence of events or broader patterns of behavior indicating significant events. The clustering algorithms may be fed training data labeled with significant events that require a higher user priority, and thus should be given prominence in presentations to the user.

Thereafter, the machine learning algorithms 433 continuously monitor the log data to update the graphs, detect significant events using clustering, and upon detecting a significant event, match the event with rules in a rules database 434. The rules database 434 stores instructions a content optimizer 440 must perform after or during a significant event is discovered or predicted. The graph engine 430 sends the rules in the form of a unique ticket that the content optimizer 440 recognizes and subsequently begins to perform particular graphical user interface (GUI) optimizations 442 and load-balancing measures 441 associated with each unique ticket. The GUI optimizations alter the properties of individual elements of a software application's GUI 442 to highlight prioritized information to the user. To highlight the prioritized information, the content optimizer 440 can dynamically change the GUI code to reduce or increase the amount of information presented on the screen, make elements on the screen more or less apparent, flash windows, change the size, location, or layout of elements, or other adjustments as fits the situation. As a simple example, the content optimizer may remove a GUI element by making the following change to a line of Java code: frame.setVisible(true); to frame.setVisible(flse); via bytecode instrumentation (changing code as it is loaded into memory). Individual GUI elements may thus be emphasized to ensure that the user's attention is drawn to the information with the greatest priority (which identified by the machine learning algorithm, heatmaps, and user configurations, depending on the embodiment)

Where the machine learning algorithms 433 detect certain events indicting insufficient bandwidth or a lack of computing resources, the content optimizer 440 may further perform load-balancing operations 441 such as sending network devices new routing information, reallocating distributed computing resources, adding or removing processing threads, omitting or deprioritizing data packet requests, etc., to ensure that information that has been identified as being high priority information is transferred to the user before information of a lower priority.

As an example of the DCMS 410, consider a network operations center (NOC). The operators in a NOC focus the majority of their attention on a video wall comprising a plurality of cybersecurity and network information and metrics. Information presented on the video wall may be deemed critical or noncritical depending on the situation at hand. Thus, during routine operations and under normal load, the DCMS 410 monitors the network for irregularities and (optionally) does not actively alter the information on the video wall. In the case of a significant event, such as a distributed-denial-of-service (DDoS) attack, in which the NOC's system's resources and bandwidth are taxed; the DCMS 410 will prioritize relevant information on the video wall in accordance with the NOC's standards; allowing for the video wall application's session to persist with information critical to managing the DDoS attack and the operators ability to interact with the software during the DDoS attack, and deprioritizing the display (or even transmission) of less important information, so as to take maximum advantage of the bandwidth still available

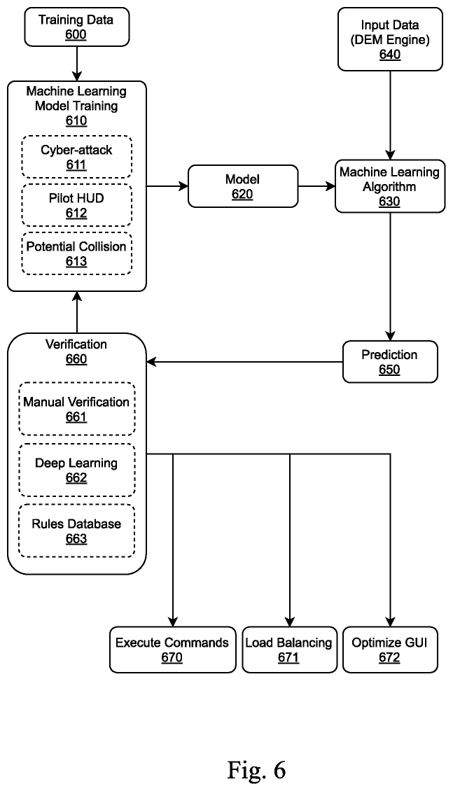

A more detailed example of the latter statement would be to eliminate or freeze topology diagrams (present in the GUI via Internet Control Message Protocol (ICMP) requests) to allow for additional processing and bandwidth to configure and send updated access control lists (ACL) to routers as one aspect of altering the GUI in response to a DDoS attack. In some embodiments, external devices 454 such as lights, buzzers, motors, and other devices designed to grab a person's attention may be used in addition to changes in the GUI to subtle or forceful cues to users of the DCMS 410 of the existence of significant events A detailed example of the machine learning model for this example can be found in FIG. 6. For example, in addition to increasing the size of a window on the GUI, the monitor on which the GUI is located may be shaken by a motor, or even moved forward toward the user on a track to ensure that the user is aware that critical information is being presented.

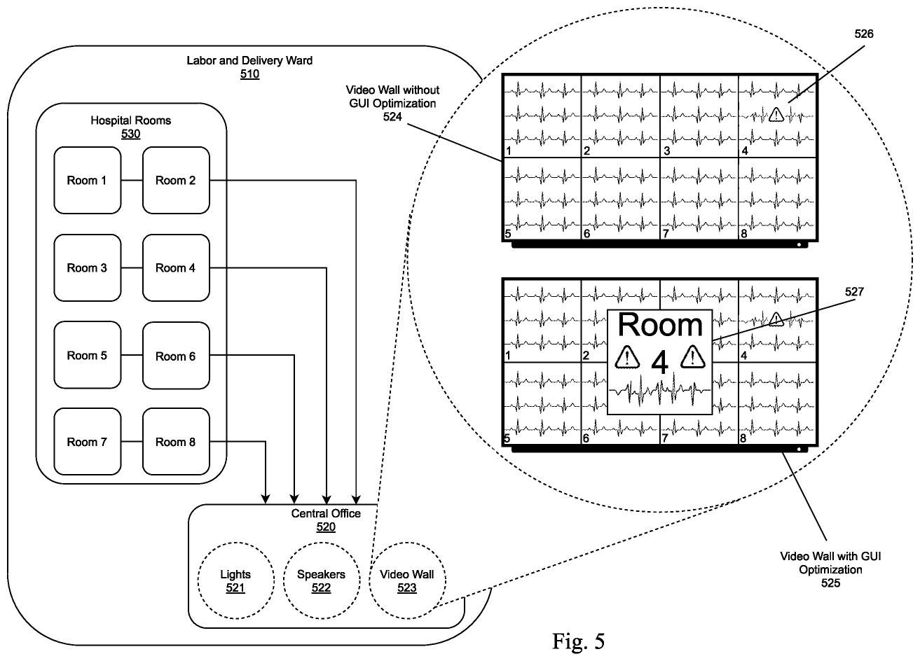

FIG. 5 is a block diagram illustrating an exemplary embodiment of a digital content management system for use in a labor and delivery ward. This embodiment is an example of using the DCMS 410 from FIG. 4 to recognize events (via vectorization and machine learning) to add GUI elements as opposed to reducing GUI elements, as in the former example of the NOC.

Consider a labor and delivery ward 510 which has eight rooms 530, of which each room has one patient. A video wall 523 displays each patient's vital signs for the hospital staff to monitor in a central location 520. The two video walls 524/525 in the figure depict a monitor without GUI optimization 524, and a monitor with GUI optimization 525. In the case of 524, Should an emergency arise, hospital staff would need to notice the critical vital signs of room four 526, which may be difficult to notice given the small scale and amount of other information. Inattentiveness is further exacerbated by exhaustion and burn out that hospital workers often experience due to long hours.

Consider now, the same emergency in room 4, now with a video wall including GUI optimization 525. The DCMS 410 through trained machine learning models recognizes the irregular vital sign pattern and alter specific GUI elements to be more prominent on the screen. Furthermore, the system 410 may incorporate other electronic devices such as lights 521 and speakers 522 to offer alternative or additional cues and alerts. As in this example, this may entail turning the central office lights 521 red and announcing the number 4 over the loudspeakers 522. A detailed example of the machine learning model for this example can be found in FIG. 6.

Further, the DCMS system may detect connection interruptions or bandwidth restrictions in the connections between the hospital rooms 530 and the central office 520, and may prioritize the transmission of data from critical equipment (e.g. heart rate monitors) and deprioritize the transmission of data from less critical equipment (e.g., room temperature sensors). The interruptions or bandwidth restrictions may themselves become events queued for prioritization by the system. For example, while intermittent, short-term interruptions may not be significant events and may be deprioritized in favor of information about immediate healthcare needs, a long-term interruption may gradually be given greater priority by the system so that the lack of room temperature information is highlighted to hospital staff when it becomes a sufficiently high priority.

### Detailed Description of Exemplary Aspects

FIG. 6 is a flow diagram of an exemplary method for the system operation of the digital content management system. As described previously, event recognition 650 may be application specific and requires training machine learning models 610. The machine learning algorithm 610 is fed training data 600, where the log data is used to generate graphs for event classification, transductive regression, clustering, and eventually creating the machine learning model 620. The predictions 650 (or event recognition) from the model algorithm 630 are verified 660 to ensure model accuracy, and may be performed by manual verification 661, deep learning jobs 662, or a rules database 663.

Once the model 620 is verified, the machine learning algorithm 630 is deployed and begins processing real-time input data 640 (log data via the event monitor 420) making actualized predictions 650 of significant events. As events are identified, the system executes any commands relating to tertiary electronic devices 672, performs load balancing 671, and optimizes the GUI 672.

One embodiment is the detection of cyber-attacks 611. Training data 600, which may comprise log data from previous cyber-attacks including all log data forty-eight hours before each attack, is fed into the machine learning model 610. As each event is vectorized and the cyber-physical graph is analyzed, patterns of behavior emerge; this comprises mysterious emails, suspicious pop-ups, slower-than-normal network speeds, port scans, and unusual login or password activity. These behaviors when detected in a particular sequence or regarding spatiotemporal thresholds, train the machine learning algorithm 610 when an attack is pending or ongoing.

Regarding the aspect of GUI optimization 672, users may manually configure a rules database 663 about which information takes priority during a specific event; or, during the machine learning model training, other types of input data 640 such as heatmap information, user journey information, input operations, and user profiles may give insight to prioritizing particular GUI elements 672 and load balancing 671 and may be further verified by human users 661.

In another example, a fighter pilot's heads-up-display (HUD) 612 may dynamically adjust to omit noncritical information during aerial combat and increase the delivery of oxygen. It may be accomplished by recognizing enemy aircraft and subsequently removing HUD elements 672 nonrelevant to the task at hand and adjusting electronic O2 valves 670. Furthermore, the control input from the fighter pilot may be used to determine when the fight is over, or in another example, when the fighter has lost consciousness and to deploy smelling salts via a pressurized delivery device.

An additional example may be changing the size and color of aircraft sprites on an air traffic controllers screen depending on a potential collision 613 rating determined by the algorithm 630 while executing commands 670 to vibrate their chair. These examples can be extended to emergency rooms, mission command centers, the financial sector, streaming media, augmented reality, verifying service level agreements, and many other applications.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

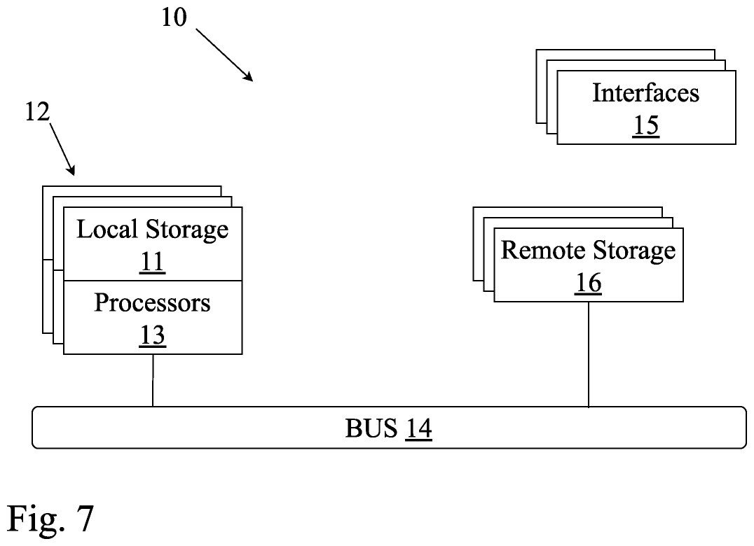

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™ THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

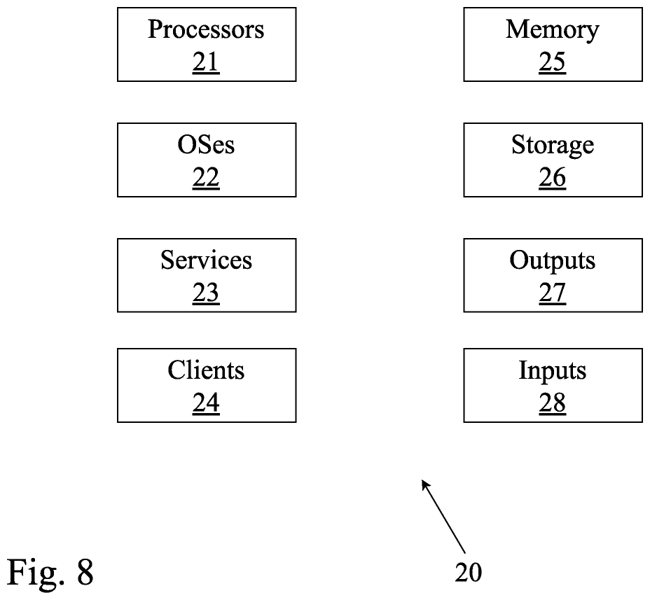

In some aspects, systems may be implemented on a standalone computing system. Referring now to FIG. 8, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20 and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 7). Examples of storage devices 26 include flash memory, magnetic hard drive, CD-ROM, and/or the like.

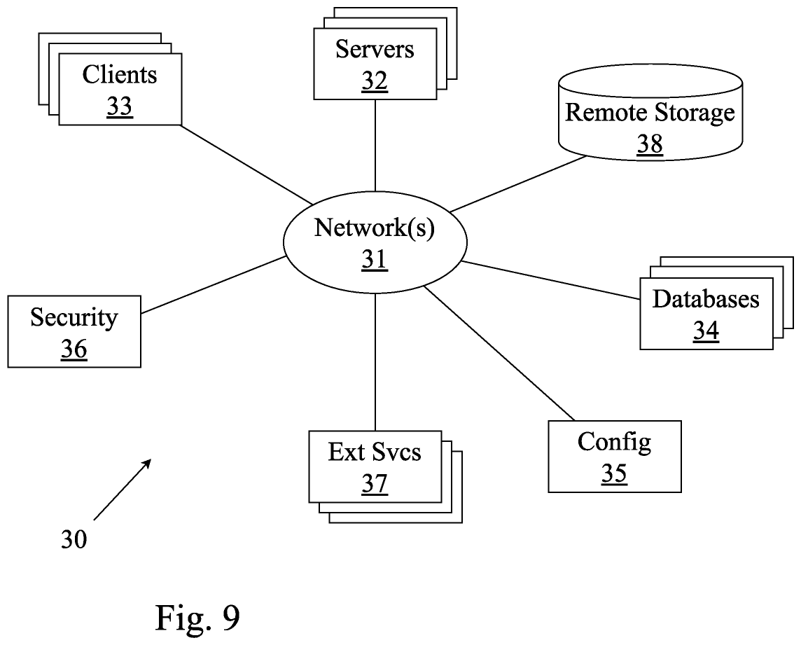

In some aspects, systems may be implemented on a distributed computing network, such as one having any number of clients and/or servers. Referring now to FIG. 9, there is shown a block diagram depicting an exemplary architecture 8 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 7. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as Wi-Fi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

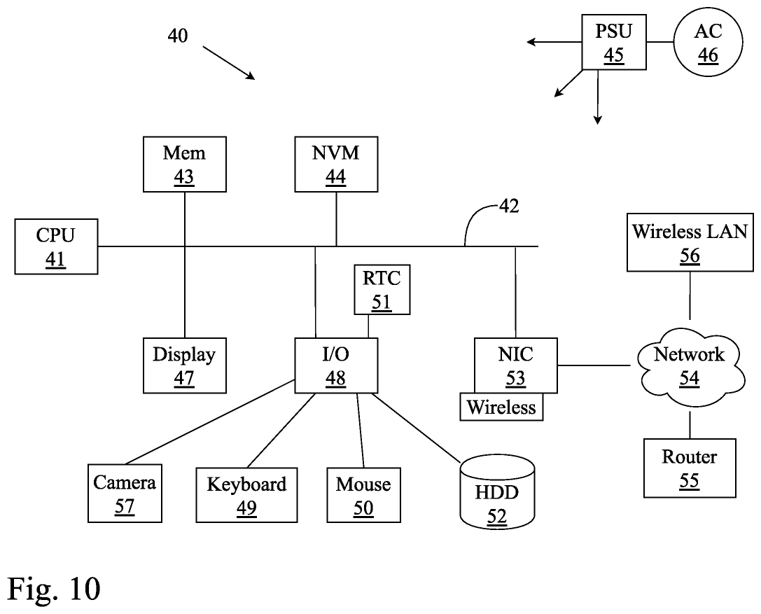

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for the prioritization and dynamic presentation of digital content, comprising:
a first network-connected computing device comprising a non-volatile storage device, a memory, and a processor;
an event monitor comprising a first plurality of programming instructions stored in the memory of, and operating on the processor of, the first computing device, wherein the first plurality of programming instructions, when operating on the processor of the computing device, cause the computing device to:
monitor and collect event data from one or more second network-connected computing devices, the event data comprising system log data;
send the event data to a graph engine; and
a graph engine comprising a second plurality of programming instructions stored in the memory of, and operating on the processor of, the first computing device, wherein the second plurality of programming instructions, when operating on the processor of the computing device, cause the computing device to:
receive the event data from the event monitor;
use a first machine learning algorithm to generate a directed graph comprising vertices representing event data points and edges representing relationships between the event data points;
use a second machine learning algorithm on the directed graph to:
identify a significant event based on clustering of event data points in the directed graph;
relate the significant event to a unique ticket;
transmit the unique ticket to a content optimizer; and
a content optimizer comprising a third plurality of programming instructions stored in the memory of, and operating on the processor of, the first computing device, wherein the third plurality of programming instructions, when operating on the processor of the computing device, cause the computing device to:
receive the unique ticket from the graph engine;
alter an element of a graphical user interface of one of the one or more second network-connected computing devices based on the unique ticket.

2. The system of claim 1, further comprising a load balancer comprising a fourth plurality of programming instructions stored in the memory of, and operating on the processor of, the first computing device, wherein the fourth plurality of programming instructions, when operating on the processor of the computing device, cause the computing device to:
receive the unique ticket;
identify a restriction of computing resources in one of the one or more second network-connected computing devices;
change a resource allocation in one or more of the second network-connected computing devices to which the one or more second computing devices is connected to prioritize the transmission or processing of data.

3. The system of claim 1, wherein the element of the graphical user interface is increased or decreased in size.

4. The system of claim 1, wherein the element of the graphical user interface is changed in color or transparency.

5. The system of claim 1, wherein the element of the graphical user interface is placed on top of other elements on the graphical user interface.

6. The system of claim 1, wherein the elements of the graphical user interface are automatically rearranged on the graphical user interface.

7. The system of claim 1, further comprising an external notification device, wherein the external notification device is used in addition to changes in the graphical user interface to direct attention to the significant event.

8. The system of claim 7, wherein the external notification device is an audio generating device.

9. The system of claim 7, wherein the external notification device is a light generating device.

10. The system of claim 7, wherein the external notification device is a vibrating device.

11. The system of claim 7, wherein the external notification device is a motor which physically moves the monitor on which the graphical user interface is displayed.

12. A method for prioritization and dynamic presentation of digital content, comprising the steps of:
monitoring and collecting event data from one or more second network-connected computing devices, the event data comprising system log data;
using a first machine learning algorithm to generate a directed graph comprising vertices representing event data points and edges representing relationships between the event data points;
using a second machine learning algorithm on the directed graph to:
identify a significant event based on clustering of event data points in the directed graph;
relate the significant event to a unique ticket;
alter an element of a graphical user interface of one of the one or more second network-connected computing devices based on the unique ticket.

13. The method of claim 12, further comprising the steps of:
receiving the unique ticket;
identifying a restriction of computing resources in one of the one or more second network-connected computing devices;
changing a resource allocation in one or more of the second network-connected computing devices to which the one or more second computing devices is connected to prioritize the transmission or processing of data.

14. The method of claim 12, wherein the element of the graphical user interface is increased or decreased in size.

15. The method of claim 12, wherein the element of the graphical user interface is changed in color or transparency.

16. The method of claim 12, wherein the element of the graphical user interface is placed on top of other elements on the graphical user interface.

17. The method of claim 12, wherein the elements of the graphical user interface are automatically rearranged on the graphical user interface.

18. The method of claim 12, further comprising an external notification device, wherein the external notification device is used in addition to changes in the graphical user interface to direct attention to the significant event.

19. The method of claim 18, wherein the external notification device is an audio generating device.

20. The method of claim 18, wherein the external notification device is a light generating device.

21. The system of claim 18, wherein the external notification device is a vibrating device.

22. The system of claim 18, wherein the external notification device is a motor which physically moves the monitor on which the graphical user interface is displayed.
